(19) United States
(12) Patent Application Publication
(10) Pub. No.: US 2024/0256814 A1
(43) Pub. Date: Aug. 1, 2024

(54) ID Alibi Hardware Application Device

(71) Applicants: Muhammad Hammad Khokhar, Valley Stream, NY (US); Muhammed Khokhar, Valley Stream, NY (US)

(72) Inventors: Muhammad Hammad Khokhar, Valley Stream, NY (US); Muhammed Khokhar, Valley Stream, NY (US)

(21) Appl. No.: 18/161,037

(22) Filed: Jan. 28, 2023

(51) Int. Cl. G06K 19/06

(52) U.S. Cl. CPC G06K 19/06037

(57) ABSTRACT

Embodiments of the present disclosure may include an on-demand QR code generating device that provides unique, one-time identifier, GPS coordinates, thermal sensor, accelerometer sensor, motion sensor, electrical sensor, gas sensor, humidity sensor, light sensor and pressure sensor readings, and other pertinent sensor data for various industry applications when activated. Embodiments may also include a self-contained, stand alone device that does not require connectivity to any form of network (e.g. internet, satellite, cellular network, external power source, cables, etc.) with a battery life of up to 10 years. Embodiments may also include a program that comprises sets of instructions for initializing the sensors and micro-controller, initializing a QR code generation software, generating a unique QR code, visually outputting the QR code on a physical digital display medium, and executing the pre-determined validity period of the displayed QR code.

### FIELD OF INVENTION

The present invention relates to the field of small form factor devices that generate unique QR codes on-demand for various applications such as inventory management, access control, event management, supply chain management, environmental monitoring, health and safety, and quality control. The invention also relates to devices comprising micro-controllers, sensors, and programs that initialize and generate QR codes, which are generally self-contained and do not require external networks or power sources.

### BACKGROUND OF THE INVENTION

Embodiments of the invention described herein relate generally to displaying a multi-purpose, on-demand, digital QR code that provides unique, one-time identifier, and/or GPS coordinates, and/or thermal, and/or accelerometer, and/or motion, and/or electrical, and/or gas, and/or humidity, and/or light, and/or pressure sensor readings, and/or other pertinent sensor data for various industry applications when activated.

Currently, digital QR code generators are single purpose devices. The most are commonly used as part of a multi-factor user authentication to prevent cyberattacks. These are produced in a form of security tokens with a small digital display, while some in the form of software application in a computer or smart device. The other QR code generators are produced to direct users to a URL address to increase website traffic or just a faster way to be directed to the web address.

But this multi-purpose QR code generating device can be customized for a wide array of applications that provides a variety of real-time data with date and time stamp validation across the globe. For example, and without limitation, the invention may be applied to a variety of uses including:

Inventory Management: The device can be placed on items in a warehouse or retail store and used to track the movement and location of those items by generating unique QR codes that can be scanned by a smartphone or other device.

Access Control: The device can be used as a keyless entry system for buildings or secured areas, where a unique QR code is generated each time someone wants to gain access.

Event Management: The device can be used at events such as conferences or trade shows to generate unique QR codes for attendees to scan when they arrive, providing a digital record of attendance.

Supply Chain Management: The device can be placed on products and used to track the movement of goods through the supply chain, providing detailed information on the location and condition of the products at any given time.

Environmental Monitoring: The device can be used in remote locations to monitor environmental conditions such as temperature, humidity, light, and pressure, and generate unique QR codes that can be scanned to retrieve that data.

Health and Safety: The device can be used in workplaces to monitor and track the health and safety of employees. For example, it can be worn by employees to track their movements and provide information on potential hazards or incidents.

Quality Control: The device can be used in manufacturing or production environments to monitor the quality of products and generate unique QR codes that can be scanned to retrieve that data.

### SUMMARY OF THE INVENTION

The following summary is an explanation of some of the general inventive steps for the system, method, devices and apparatus in the description. This summary is not an extensive overview of the invention and does not intend to limit its scope beyond what is described and claimed as a summary.

A multi-purpose, on-demand, digital QR code generating device that provides unique, one-time identifier code, and/or GPS coordinates, and/or thermal, and/or accelerometer, and/or motion, and/or electrical, and/or gas, and/or humidity, and/or light, and/or pressure sensor readings, and/or other pertinent sensor data when activated.

This device is small in form, is inexpensive to produce, is a self-contained, stand-alone device that does not require connectivity to any form of network (e.g. internet, satellite, cellular network, external power source, cables, etc.) with a battery life of up to 10 years.

The method for this multi-purpose on-demand, digital QR code generating device that provides unique, one-time identifier code, and/or GPS coordinates, and/or thermal, and/or accelerometer, and/or motion, and/or electrical, and/or gas, and/or humidity, and/or light, and/or pressure sensor readings, and/or other pertinent sensor data includes a plurality of steps comprising (i) triggering a Control device, (ii) initializing a micro-controller with Real-Time Clock (RTC), a QR code generation software, and/or unique, one-time identifier code, and/or GPS locator, and/or thermal, and/or accelerometer, and/or motion, and/or electrical, and/or gas, and/or humidity, and/or light, and/or pressure sensor readings, and/or other pertinent sensor data, (iii) generating a unique QR code, and (iv) visually outputting the unique QR code for display on a digital screen like e-paper or LCD display, and (v) executing the pre-defined validity period of the displayed QR code.

The preceding Summary is intended to serve as an introduction to some embodiments of the invention. It is not meant to be an overview of all inventive subject matter disclosed in this specification. The Detailed Description that follows and the Drawings that are referred to in the Detailed Description will further describe the embodiments described in the Summary as well as other embodiments. Accordingly, to understand all the embodiments described by this document, a full review of the Summary, Detailed Description, and Drawings is needed. Moreover, the claimed subject matters are not to be limited by the illustrative details in the Summary, Detailed Description, and Drawings, but rather are to be defined by the appended claims, because the claimed subject matter can be embodied in other specific forms without departing from the spirit of the subject matter.

### BRIEF DESCRIPTION OF THE DRAWINGS

The novel features believed to be characteristic of the illustrative embodiments are set forth in the appended claims. The illustrative embodiments, however, as well as a preferred mode of use, further objectives and descriptions thereof, will best be understood by reference to the following detailed description of one or more illustrative embodiments of the present disclosure when read in conjunction with the accompanying drawings, wherein:

FIG. 1 illustrates a method for generating a multi-purpose, on-demand, digital QR code that provides unique, one-time identifier code, and/or GPS coordinates, and/or thermal, and/or accelerometer, and/or motion, and/or electrical, and/or gas, and/or humidity, and/or light, and/or pressure sensor readings, and/or other pertinent sensor data

FIG. 2 illustrates a diagram of initializing the micro-controller with identifier code generator, and/or GPS locator, and/or thermal sensor, and/or accelerometer sensor, and/or motion sensor, and/or electrical sensor, and/or gas sensor, and/or humidity sensor, and/or light sensor, and/or pressure sensor, and/or other pertinent sensor data and the generated unique digital QR code display.

FIG. 3 illustrates a block diagram of a powered, multi-purpose, on-demand, digital QR code in some embodiments.

FIG. 4 conceptually illustrates a self-contained, multi-purpose, on-demand digital QR generation method for unique, one-time identifier code, and/or GPS coordinates, and/or thermal, and/or accelerometer, and/or motion, and/or electrical, and/or gas, and/or humidity, and/or light, and/or pressure sensor readings, and/or other pertinent sensor data.

### DETAILED DESCRIPTION OF THE PREFERRED EMBODIMENTS

In the following detailed description of the invention, numerous details, examples, and embodiments of the invention are described. However, it will be clear and apparent to those knowledgeable in the field that the invention is not limited to the embodiments set forth and that the invention can be adapted for a wider range of applications.

Some embodiments of the invention include a method for this multi-purpose, on-demand, digital QR code generating device that provides unique, one-time identifier code, and/or GPS coordinates, and/or thermal, and/or accelerometer, and/or motion, and/or electrical, and/or gas, and/or humidity, and/or light, and/or pressure sensor readings, and/or other pertinent sensor data are disclosed.

In some embodiments, the device can be tailored with a combination of two (2) or more hardware, sensors, or data to provide information pertinent its function in the form of an on-demand digital QR code display. This multi-purpose on-demand, digital QR code generating device that provides unique, one-time identifier code, and/or GPS coordinates, and/or thermal, and/or accelerometer, and/or motion, and/or electrical, and/or gas, and/or humidity, and/or light, and/or pressure sensor readings, and/or other pertinent sensor data has a small form factor, is inexpensive, and is a self-contained, stand-alone device that does not require connectivity to any form of network (e.g. internet, satellite, cellular network, external power source, cables, etc.) with a battery life of up to 10 years.

The method for this device includes a plurality of steps comprising (i) triggering a Control device, (ii) initializing a micro-controller with Real-Time Clock (RTC), a QR code generation software, and/or identifier code generator, and/or GPS locator, and/or thermal sensor, and/or accelerometer sensor, and/or motion sensor, and/or electrical sensor, and/or gas sensor, and/or humidity sensor, and/or light sensor, and/or pressure sensor, and/or other pertinent sensor data, (iii) generating a unique QR code, and (iv) visually outputting the unique QR code for display on a digital screen like e-paper or LCD display, and (v) executing the pre-defined validity period of the displayed QR code.

As stated above, current QR code generating devices are singular in function with most being commonly used as part of a multi-factor user authentication to prevent cyberattacks. These are produced in a form of security tokens with a small digital display, while some in the form of software application in a computer or smart device. The other QR code generators are produced to direct users to a URL address to increase website traffic or just a faster way to be directed to the web address.

This multi-purpose QR code generating device however, can be customized for a wide array of applications that provides a variety of real-time data with date and time stamp validation across the globe.

Embodiments of the invention described in this specification addresses the process of initializing the device with a combination of two (2) or more hardware, sensors, or data for a wide range of applications.

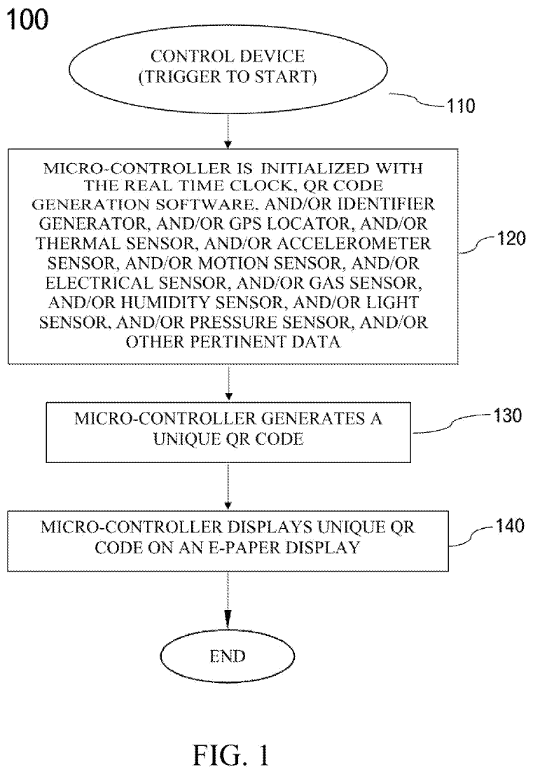

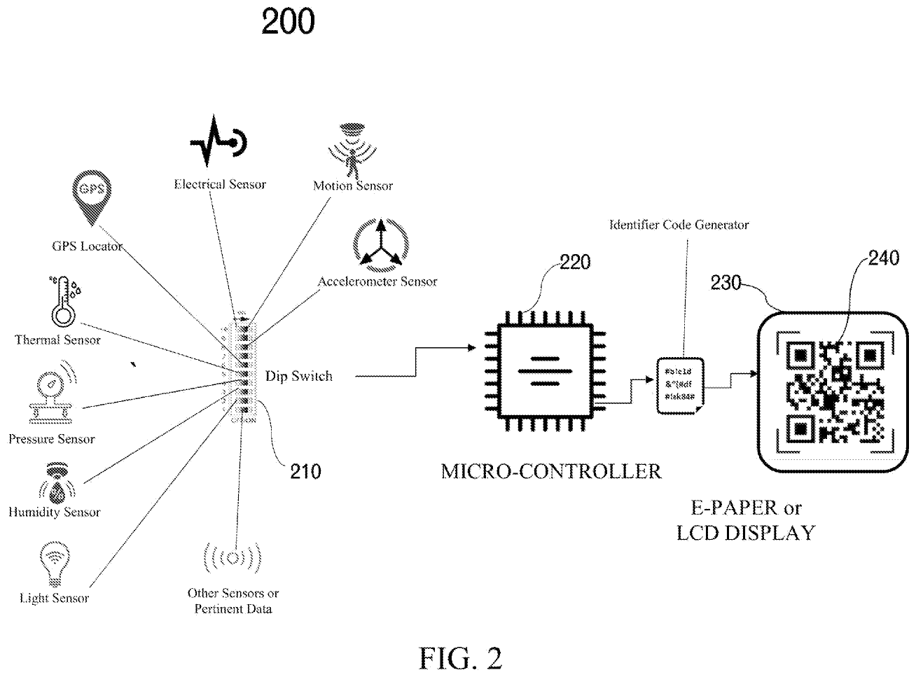

By way of example, FIG. 1 illustrates a method for a multi-purpose on-demand, digital QR code generating device that provides unique, one-time identifier code, and/or GPS coordinates, and/or thermal, and/or accelerometer, and/or motion, and/or electrical, and/or gas, and/or humidity, and/or light, and/or pressure sensor readings, and/or other pertinent sensor data (100). An example of the multi-purpose on-demand, digital QR code generating device that provides unique, one-time identifier code, and/or GPS coordinates, and/or thermal, and/or accelerometer, and/or motion, and/or electrical, and/or gas, and/or humidity, and/or light, and/or pressure sensor readings, and/or other pertinent sensor data is described below by reference to FIG. 2. In some embodiments, the method of a multi-purpose on-demand, digital QR code generating device that provides unique, one-time identifier code, and/or GPS coordinates, and/or thermal, and/or accelerometer, and/or motion, and/or electrical, and/or gas, and/or humidity, and/or light, and/or pressure sensor readings, and/or other pertinent sensor data (100) starts with triggering a control device to power up the circuit (at 110), initializing a micro-controller (at 120) with Real-Time Clock (RTC), a QR code generation software, and/or identifier code generator, and/or GPS locator, and/or thermal sensor, and/or accelerometer sensor, and/or motion sensor, and/or electrical sensor, and/or gas sensor, and/or humidity sensor, and/or light sensor, and/or pressure sensor, and/or other pertinent sensor data.

In some embodiments, the Real-Time Clock (RTC), a QR code generation software, and/or identifier code generator, and/or GPS locator, and/or thermal sensor, and/or accelerometer sensor, and/or motion sensor, and/or electrical sensor, and/or gas sensor, and/or humidity sensor, and/or light sensor, and/or pressure sensor, and/or other pertinent sensor data is installed and initialized on the micro-controller.

In some embodiments, the method of this invention continues to the next step (130) during which the micro-controller generates a unique QR code. In some embodiments, the method of this invention (100) uses the RTC data, identifier code generator, and/or GPS coordinates, and/or thermal, and/or accelerometer, and/or motion, and/or electrical, and/or gas, and/or humidity, and/or light, and/or pressure sensor readings, and/or other pertinent sensor data installed and initialized on the micro-controller to generate a unique QR code. Once the QR is generated, it is then ready to be visually shown onto the digital display of the device.

Finally, the method proceeds to the last step (at 140) during which the micro-controller displays the generated QR code onto the digital display of the device. Thus, in some embodiments, when a new QR code is requested upon demand, the digital display of the device is updated with the new unique QR code, otherwise the micro-controller will cease the visual display on the digital screen of the device after a pre-determined period.

Embodiments of this invention described in this specification differ from and improve upon currently existing options. In particular, some embodiments differ from existing systems that is used for a single function only. Typically, using QR codes as an alternative to OTP generators. These come in a form of a security token with a small digital display or an application run by a computer or smart device. Other systems generate QR codes to automatically direct users to a specific URL address or a website.

In contrast, this invention (100) is a multi-purpose on-demand, digital QR code generating device that provides unique, one-time identifier code, and/or GPS coordinates, and/or thermal, and/or accelerometer, and/or motion, and/or electrical, and/or gas, and/or humidity, and/or light, and/or pressure sensor readings, and/or other pertinent sensor data.

Persons having ordinary skill in the art relevant to the present disclosure may understand there to be equivalent elements that may be substituted within the present disclosure without changing the essential function or operation of this invention.
1. Control Device (such as button, switch or lever)
2. Micro-controller
3. RTC module
4. Identifier Code Generator
5. GPS Locator
6. Thermal sensor
7. Accelerometer sensor
8. Motion sensor
9. Electrical sensor
10. Gas sensor
11. Humidity sensor
12. Light sensor
13. Pressure sensor
14. Dip Switch
15. Battery
16. QR Code generation software
17. Physical digital display medium, either a digital screen (such as an LCD screen or an e-paper).

This multi-purpose, on-demand, digital QR code generating device that provides unique, one-time identifier code, and/or GPS coordinates, and/or thermal, and/or accelerometer, and/or motion, and/or electrical, and/or gas, and/or humidity, and/or light, and/or pressure sensor readings, and/or other pertinent sensor data generally works by way of the micro-controller, which is at the heart of the device and is responsible for running each step of the method for generating a unique QR code. Specifically, the micro-controller is initialized with the RTC module, QR Code Generator software, and/or identifier code generator, and/or GPS locator, and/or thermal sensor, and/or accelerometer sensor, and/or motion sensor, and/or electrical sensor, and/or gas sensor, and/or humidity sensor, and/or light sensor, and/or pressure sensor, and/or other pertinent sensor data that is used to generate each subsequent unique QR code. Then the micro-controller displays the generated QR code on the physical digital display medium. In some embodiments, the physical digital display medium comprises an e-paper, LCD screen, or other form of digital display. In some embodiments, the micro-controller repeats the process on demand by activating a control device (at 110), otherwise, the micro-controller executes the pre-determined validity of the latest generated QR code and cease the visual display of the QR code on the physical digital display of the device. Therefore, in order to generate a new unique QR code onto the digital display, the control device must first be triggered.

By way of example, FIG. 2 conceptually illustrates the invention (200) with an identifier code generator, and/or GPS locator, and/or thermal sensor, and/or accelerometer sensor, and/or motion sensor, and/or electrical sensor, and/or gas sensor, and/or humidity sensor, and/or light sensor, and/or pressure sensor, and/or other sensors managed by a dip switch to control the output data (210), a micro-controller (220), RTC module (not shown in figure), QR Code Generating software (not shown in figure), a display device (230) on which the unique QR code (240) is displayed.

In some embodiments, identifier code generator, and/or GPS locator, and/or thermal sensor, and/or accelerometer sensor, and/or motion sensor, and/or electrical sensor, and/or gas sensor, and/or humidity sensor, and/or light sensor, and/or pressure sensor, and/or other sensors are used as components in building the unique QR code (200).

In some embodiments, the micro-controller (220) could be a true micro-controller (like a PIC micro-controller), or it may be a small processing unit (like an Arduino, Teensy, Raspberry Pi, etc.). When the component is built, the Real Time Clock (RTC), the QR code generation software, identifier code generator, and GPS locator, and thermal sensor, and accelerometer sensor, and motion sensor, and electrical sensor, and gas sensor, and humidity sensor, and light sensor, and pressure sensor, and other sensors will be installed on the micro-controller (220). Whether it is possible to reprogram the micro-controller (220) may be optional to prevent tampering device, or to prevent additional software from being installed.

In some embodiments, the QR code generation software converts the output data into a unique QR code (240) to be shown on the digital display medium (230).

In some embodiments, this multi-purpose, on-demand, digital QR code generating device that provides unique, one-time identifier code, and/or GPS coordinates, and/or thermal, and/or accelerometer, and/or motion, and/or electrical, and/or gas, and/or humidity, and/or light, and/or pressure sensor readings, and/or other pertinent sensor data is a self-contained, stand-alone device that does not require connectivity to any form of network (e.g. internet, satellite, cellular network, external power source, cables, etc.). Overall, this invention (200) provides a simple, inexpensive way to provide various pertinent sensor data in a single uniquely generated QR code.

In some embodiments, this multi-purpose, on-demand, digital QR code generating device that provides unique, one-time identifier code, and/or GPS coordinates, and/or thermal, and/or accelerometer, and/or motion, and/or electrical, and/or gas, and/or humidity, and/or light, and/or pressure sensor readings, and/or other pertinent sensor data includes a power source. In some embodiments, the source of power comprises of a battery that provides electric power to the various sensors, the micro-controller, and the digital display onto which the generated unique QR codes are shown. In some embodiments, the source of power is a battery bank comprising a plurality of batteries. This multi-purpose, on-demand, digital QR code generating device that provides unique, one-time identifier code, and/or GPS coordinates, and/or thermal, and/or accelerometer, and/or motion, and/or electrical, and/or gas, and/or humidity, and/or light, and/or pressure sensor readings, and/or other pertinent sensor data is low powered, and that the embedded battery can power the sensors, micro-controller and a small digital display like e-paper, for up to 10 years.

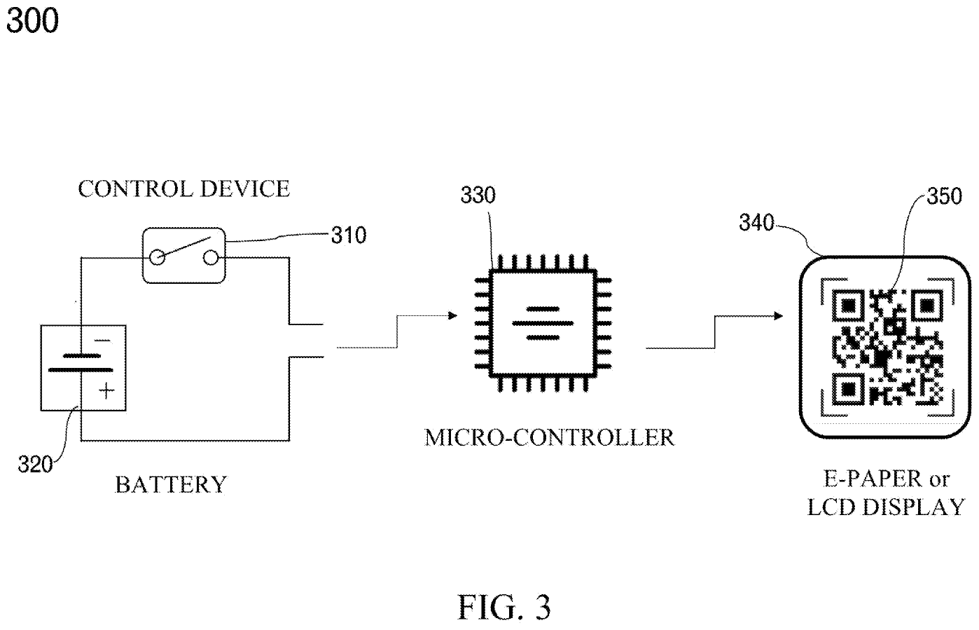

By way of example, FIG. 3 conceptually illustrates example of a powered multi-purpose, on-demand, digital QR code generating device that provides unique, one-time identifier code, and/or GPS coordinates, and/or thermal, and/or accelerometer, and/or motion, and/or electrical, and/or gas, and/or humidity, and/or light, and/or pressure sensor readings, and/or other pertinent sensor data (300). As shown in this figure, this multi-purpose, on-demand, digital QR code generating device that provides unique, one-time identifier code, and/or GPS coordinates, and/or thermal, and/or accelerometer, and/or motion, and/or electrical, and/or gas, and/or humidity, and/or light, and/or pressure sensor readings, and/or other pertinent sensor data (300) includes the low powered energy source like a battery (320), the control device (310), the micro-controller (330), and the digital display medium (340). The control device (310) is the component that enables the multi-purpose, on-demand, digital QR code generating device that provides unique, one-time identifier code, and/or GPS coordinates, and/or thermal, and/or accelerometer, and/or motion, and/or electrical, and/or gas, and/or humidity, and/or light, and/or pressure sensor readings, and/or other pertinent sensor data (300) to conserve its power source and utilize energy only upon triggering the control device (310) for a new and unique QR code to be generated and displayed.

In some embodiments, the method of generating an multi-purpose, on-demand, digital QR code that provides unique, one-time identifier code, and/or GPS coordinates, and/or thermal, and/or accelerometer, and/or motion, and/or electrical, and/or gas, and/or humidity, and/or light, and/or pressure sensor readings, and/or other pertinent sensor data, is a high-level method that involves expanded plurality of steps comprising (i) triggering a Control device, (ii) initializing a micro-controller with Real-Time Clock (RTC), a QR code generation software, and/or identifier code generator, and/or GPS locator, and/or thermal sensor, and/or accelerometer sensor, and/or motion sensor, and/or electrical sensor, and/or gas sensor, and/or humidity sensor, and/or light sensor, and/or pressure sensor, and/or other pertinent sensor data, (iii) generating a unique QR code, and (iv) visually outputting the unique QR code for display on a digital screen like e-paper or LCD display, and (v) executing the pre-defined validity period of the displayed QR code.

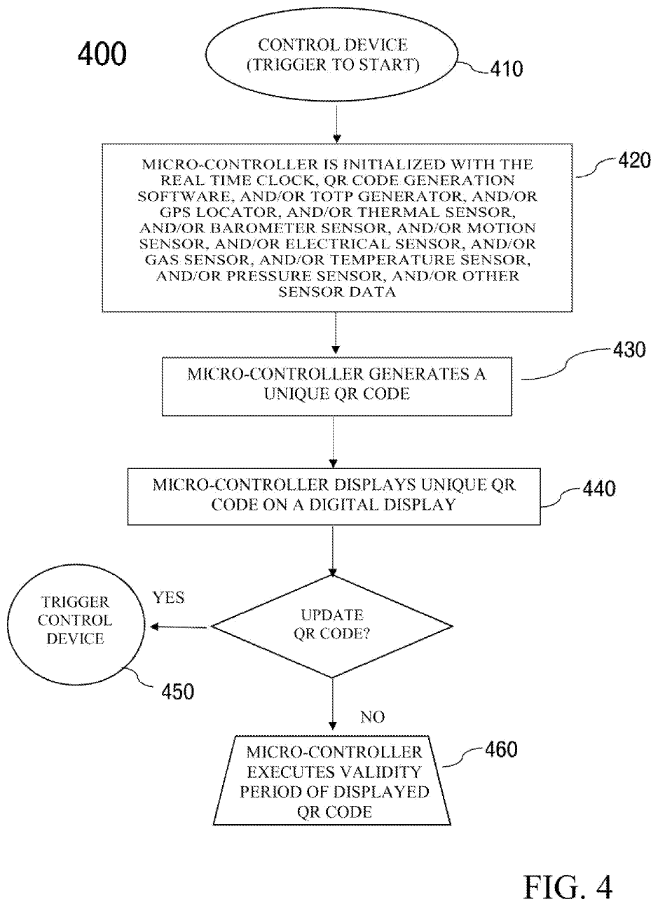

By way of example, FIG. 4 conceptually illustrates a multi-purpose, on-demand, digital QR code generating device that provides unique, one-time identifier code, and/or GPS coordinates, and/or thermal, and/or accelerometer, and/or motion, and/or electrical, and/or gas, and/or humidity, and/or light, and/or pressure sensor readings, and/or other pertinent sensor data (400). FIGS. 2-3. In some embodiments, the multi-purpose, on-demand, digital QR code generating device that provides unique, one-time identifier code, and/or GPS coordinates, and/or thermal, and/or accelerometer, and/or motion, and/or electrical, and/or gas, and/or humidity, and/or light, and/or pressure sensor readings, and/or other pertinent sensor data (400) starts with triggering the control device to power the circuit (410), then the initialization (at 420) of the micro-controller with Real-Time Clock (RTC), a QR code generation software, and/or identifier code generator, and/or GPS locator, and/or thermal sensor, and/or accelerometer sensor, and/or motion sensor, and/or electrical sensor, and/or gas sensor, and/or humidity sensor, and/or light sensor, and/or pressure sensor, and/or other pertinent sensor or data.

The QR code generation for a multi-purpose, on-demand, digital QR code generating device (400) continues to the next step (at 430) during which the micro-controller generates a unique QR. Next, multi-purpose, on-demand, digital QR code generating device (400) proceeds to the next step during which the micro-controller displays the unique QR code on a digital display (440).

Lastly, the multi-purpose, on-demand, digital QR code generating device (400) proceeds with the function of manually triggering a control device (at 450) to generate a new and unique QR code to be displayed, or the micro-controller executes the pre-determined validity period of the displayed QR code at (460).

In some embodiments, the multi-purpose, on-demand, digital QR code generating device as presently disclosed, can be widely adapted for use in various industries.

While the invention has been described with reference to numerous specific sensors, one of ordinary knowledge in the field will recognize that the invention can be embodied in other specific forms without departing from the spirit of the invention. For instance, FIGS. 1 and 4 conceptually illustrate processes or methods in which the specific operations of these processes or methods may not be performed in the exact order shown and described. Specific operations may not be performed in one continuous series of operations, and different specific operations may be performed in different embodiments.

Furthermore, the processes or methods could be implemented using several sub-processes, or as part of a larger macro process. Thus, one of ordinary skill in the art would understand that the invention is not to be limited by the foregoing illustrative details, but rather is to be defined by the appended claims.

It is expected that when program instructions that are readable by a computer are provided to a processor of a general purpose computer, special purpose computer, or other programmable data processing device to create a machine, these instructions, which are executed by the processor of the computer or other programmable data processing device, will create means for carrying out the functions or actions specified in the flowchart and/or block diagram. Therefore, program instructions that can be read by a computer may also be stored in a computer readable storage medium that can direct a computer, a programmable data processing device, and/or other devices to function in a particular way, such that the computer readable storage medium containing the stored instructions is considered an article that includes instructions for implementing aspects of the function or action specified in the flowchart and/or block diagram.

While a preferred embodiment of the present invention has been described for illustrative purposes, those skilled in the art will recognize that various modifications, additions, and substitutions are possible without departing from the scope and spirit of the invention as claimed in the accompanying claims. Such changes are anticipated by the applicant.

As a result, the applicant intends to include all such alternatives, modifications, equivalents, and variations that fall within the scope and spirit of the disclosed subject matter. It should also be understood that references to items in the singular include the plural and vice versa, unless explicitly stated otherwise or clear from the context. Grammatical conjunctions should be understood to express any and all combinations of clauses, sentences, words, and the like that are disjunctive or conjunctive, unless otherwise stated or clear from the context. Therefore, the term “or” should generally be understood to mean “and/or” and so on.

### INDUSTRIAL APPLICATION

The current invention is applicable to devices for cryptography. The invention, additionally has potential industrial applications including in industrial settings requiring inventory management, access control, event management, supply chain management, environmental monitoring, health and safety, and quality control.

What is claimed is:

1. A small form factor device storing a program which, when triggered by a control device, the micro-controller displays a unique QR code that provides unique, one-time identifier code, and/or GPS coordinates, and/or thermal, and/or accelerometer, and/or motion, and/or electrical, and/or gas, and/or humidity, and/or light, and/or pressure sensor readings, and/or other pertinent sensor data, with the said program comprising sets of instructions for:
initializing the micro-controller with Real-Time Clock (RTC), and/or identifier code generator, and/or GPS locator, and/or thermal sensor, and/or accelerometer sensor, and/or motion sensor, and/or electrical sensor, and/or gas sensor, and/or humidity sensor, and/or light sensor, and/or pressure sensor, and/or other pertinent sensors in a self-contained, multi-purpose, on-demand, digital QR code generating device;
initializing a QR code generation software on the micro-controller in a self-contained, multi-purpose, on-demand, digital QR code generating device;
generating a unique QR code from Real-Time Clock (RTC), and/or identifier code generator, and/or GPS locator, and/or thermal sensor, and/or
accelerometer sensor, and/or motion sensor, and/or electrical sensor, and/or gas sensor, and/or humidity sensor, and/or light sensor, and/or pressure sensor, and/or other pertinent sensor by the multi-purpose, on-demand, digital QR code generating device;
visually outputting the unique QR code, by the micro-controller, for display on the physical digital display medium of the self-contained, multi-purpose, on-demand, digital QR code generating device;
triggering the control device to generate a new and unique QR code that refers to the particular information resource by the micro-controller, and display the generated QR code on the physical digital display medium of the self-contained, multi-purpose, on-demand, digital QR code generating device, and;
execution of the pre-determined validity period of the displayed QR code that refers to the particular information resource by the micro-controller, and cease the visual output of the QR code on the physical digital display medium.

2. The device of claim 1, wherein when triggered by a control device, the micro-controller generates a new and unique QR code that differs from any previously generated QR code, wherein the program comprises of sets of instructions for:
waiting to generate a new and unique QR code upon trigger of the control device;
visually displaying the unique QR code in the physical digital display medium, and;
executing the pre-determined validity period of the displayed QR code and cease the visual output of the QR code on the physical digital display medium.

3. The device of claim 2, wherein the QR code is visually output for display on a physical digital display medium (like an e-paper, LCD screen, or other digital screen).

4. The device of claim 2, wherein the displayed QR code on the digital display medium has a pre-determined validity period and will cease the visual display on the digital display medium.

5. A stand-alone, self-contained, multi-purpose, on-demand, digital QR code generating device that does not require connectivity to any form of network (e.g. internet, satellite, cellular network, external power source, cables, etc.) with a battery life of up to 10 years, with the said device comprising:
a. Control Device (such as button, switch or lever);
b. Micro-controller;
c. RTC module;
d. Identifier Code Generator;
e. GPS Locator;
f. Thermal sensor;
g. Accelerometer sensor;
h. Motion sensor;
i. Electrical sensor;
j. Gas sensor;
k. Humidity sensor;
l. Light sensor;
m. Pressure sensor;
n. Dip Switch to manage the output data being processed by the micro-controller;
o. a low power energy source that provides power to the sensors,
micro-controller, and the physical digital display of the device;
p. QR Code generation software that is used to generate output data into QR codes, and;
q. Physical digital display medium, either a digital screen (such as an LCD screen or an e-paper) configured to visually output each new encrypted QR code associated with the particular information resource.

6. The device of claim 5, wherein the physical display medium comprises one of an e-paper, LCD, or other form of digital display.

7. The device of claim 5, wherein the low power energy source that provides power to the micro-controller and the physical digital display comprises of one or several batteries that is embedded within the device.

8. The device of claim 5, wherein low power consumption of the device allows for a life-cycle of up to 10 years without the requirement of an external power source.

9. A non-transitory computer readable medium storing a sequence of program instructions thereon, which program instructions when configured on a memory and executed by a processor of a small form factor device when triggered by a control device, causes the display by a micro-controller a unique QR code that provides unique, one-time identifier code, and/or GPS coordinates, and/or thermal, and/or accelerometer, and/or motion, and/or electrical, and/or gas, and/or humidity, and/or light, and/or pressure sensor readings, and/or other pertinent sensor data, by the execution of a method comprising:
initializing the micro-controller with Real-Time Clock (RTC), and/or identifier code generator, and/or GPS locator, and/or thermal sensor, and/or accelerometer sensor, and/or motion sensor, and/or electrical sensor, and/or gas sensor, and/or humidity sensor, and/or light sensor, and/or pressure sensor, and/or other pertinent sensors in a self-contained, multi-purpose, on-demand, digital QR code generating device;
initializing a QR code generation software on the micro-controller in a self-contained, multi-purpose, on-demand, digital QR code generating device;
generating a unique QR code from Real-Time Clock (RTC), and/or identifier code generator, and/or GPS locator, and/or thermal sensor, and/or
accelerometer sensor, and/or motion sensor, and/or electrical sensor, and/or gas sensor, and/or humidity sensor, and/or light sensor, and/or pressure sensor, and/or other pertinent sensor by the multi-purpose, on-demand, digital QR code generating device;
visually outputting the unique QR code, by the micro-controller, for display on the physical digital display medium of the self-contained, multi-purpose, on-demand, digital QR code generating device;
triggering the control device to generate a new and unique QR code that refers to the particular information resource by the micro-controller, and display the generated QR code on the physical digital display medium of the self-contained, multi-purpose, on-demand, digital QR code generating device, and;
execution of the pre-determined validity period of the displayed QR code that refers to the particular information resource by the micro-controller, and cease the visual output of the QR code on the physical digital display medium.

10. The method of claim 9, wherein when triggered by a control device, the micro-controller generates a new and unique QR code that differs from any previously generated QR code, wherein the program comprises of sets of instructions for:
waiting to generate a new and unique QR code upon trigger of the control device;
visually displaying the unique QR code in the physical digital display medium, and;
executing the pre-determined validity period of the displayed QR code and cease the visual output of the QR code on the physical digital display medium.

11. The device of claim 10, wherein the QR code is visually output for display on a physical digital display medium (like an e-paper, LCD screen, or other digital screen).

12. The device of claim 10, wherein the displayed QR code on the digital display medium has a pre-determined validity period and will cease the visual display on the digital display medium.
